(19) United States
(12) Patent Application Publication
(10) Pub. No.: US 2018/0147771 A1
(43) Pub. Date: May 31, 2018

(54) APPARATUS FOR FORMING PLASTIC FUEL TANK FOR VEHICLE

(71) Applicant: DONG HEE INDUSTRIAL CO., LTD., Ulsan (KR)

(72) Inventor: Jung Keun YOO, Cheonan-si (KR)

(73) Assignee: DONG HEE INDUSTRIAL CO., LTD., Ulsan (KR)

(21) Appl. No.: 15/826,574

(22) Filed: Nov. 29, 2017

(30) Foreign Application Priority Data
Nov. 29, 2016 (KR) 10-2016-0160654

(51) Int. Cl. B29C 49/28; B29C 49/00; B29C 65/02; B29C 65/00; B29C 49/48; B29C 49/78

(52) U.S. Cl. CPC B29C 49/28; B29C 49/0047; B29C 65/02; B29L 2031/7172; B29C 49/48; B29C 49/783; B29C 2949/78537; B29C 66/4326

(57) ABSTRACT

Disclosed is an apparatus for forming a plastic fuel tank for a vehicle, wherein when a parison is formed into semi-finished products having a shape of the fuel tank, the semi-finished products are formed by press forming using first and second molds and an intermediate mold. The semi-finished products are formed without using a blow molding process.

### CROSS-REFERENCE TO RELATED APPLICATION

The present application claims priority to Korean Patent Application No. 10-2016-0160654, filed Nov. 29, 2016, the entire contents of which is incorporated herein for all purposes by this reference.

### BACKGROUND

### Field

The present disclosure relates generally to an apparatus for molding a plastic fuel tank. More particularly, the present disclosure relates to an apparatus for forming a plastic fuel tank using a parison, the apparatus being capable of realizing uniform cross-sectional thickness of a formed plastic fuel tank.

### Description of the Related Art

In general, an engine of a vehicle is a device that converts thermal energy into mechanical rotational force by rotating a crankshaft using an explosive force generated by burning fuel in a combustion chamber.

In such an engine, fuel to be burned in the combustion chamber must be continuously supplied thereto, and a fuel tank storing a certain amount of fuel is provided in the vehicle for continuous supply of the fuel.

The fuel tank is usually made of steel or plastic. In recent years, however, a plastic fuel tank has been increasingly used for weight reduction and fuel mileage improvement.

The plastic fuel tank is manufactured through a melting process, an extrusion process, and a forming process. The melting process is a process of melting a plastic material by applying high temperature heat to obtain a molten resin. The extrusion process is a process of extruding the molten resin into a C-shaped parison, a twin-sheet parison, a cylinder-shaped parison, etc. The forming process is a process of forming a parison in a shape of the fuel tank using a mold.

The foregoing is intended merely to aid in the understanding of the background of the present invention, and is not intended to mean that the present invention falls within the purview of the related art that is already known to those skilled in the art.

### SUMMARY

The present disclosure provides an apparatus for forming a plastic fuel tank for a vehicle, wherein when a parison is formed into semi-finished products having a shape of the fuel tank, the semi-finished products are manufactured by press forming using molds and an intermediate mold instead of blow molding, whereby the manufactured semi-finished product has uniform cross-section thickness over the entire area. Accordingly, the manufactured plastic fuel tank has uniform dimension in the cross-sectional thickness, thereby realizing uniform cross-sectional thickness of the final product. As a result, the final product that is the manufactured plastic fuel tank has improved durability and improved quality.

In order to achieve the above object, according to one aspect of the present invention, there is provided an apparatus for forming a plastic fuel tank for a vehicle, the apparatus forming a parison into semi-finished products having a shape of the fuel tank and forming the semi-finished products into a finished plastic fuel tank, the apparatus including: first and second molds configured to be combined and separated from each other; and an intermediate mold configured to be inserted between and withdrawn from the first and second molds, wherein when the parison is formed into the semi-finished products, the intermediate mold is positioned inside the parison and serves as a core, and when the first and second molds are combined, the first and second molds press an outer surface of the parison and the intermediate mold supports an inner surface of the parison, whereby the parison is formed into the semi-finished products.

The intermediate mold may include: a body portion inserted into cavities of the first and second molds when the first and second molds are combined; and a flange portion protruding outward from the body portion and positioned between the first and second molds at a position outside the cavities when the first and second molds are combined.

The body portion of the intermediate mold may have a rectangular-shaped cross section having round corners.

The body portion of the intermediate mold may be provided with a needle pin forming a hole at at least one of the semi-finished products and a plastic part heat-welded onto an inner surface of the semi-finished product; and the needle pin and the plastic part are placed inside the body portion of the intermediate mold until the parison is formed into the semi-finished products in a state in which the first and second molds are combined, and after the parison is formed into the semi-finished products in the state in which the first and second molds are combined, the needle pin and the plastic part protrude out of the body portion of the intermediate mold whereby the needle pin forms the hole at the semi-finished product and the plastic part is heat-welded onto the inner surface of the semi-finished product.

The apparatus may further include: a plurality of air passages provided at the first and second molds, and communicating with the cavities of the first and second molds; an air pump connected to the air passages through a plurality of air lines; and control valves provided on the air lines, respectively, and configured to allow the air passages and the air pump to be connected to each other and to allow the air passages and atmosphere to communicate with each other in accordance with control of a controller.

In a horizontal cross-section of the first and second molds, the air passages may include first passages passing through horizontal walls of the cavities, second passages passing through corners of the cavities, and third passages passing through vertical walls of the cavities.

In a first stage in which the intermediate mold is inserted into the parison before combining of the first and second molds begins and forming of the parison into the semi-finished products begins, the first, second, and third air passages may be connected to the atmosphere and serve as an air vent; in a second stage in which the combining of the first and second molds begins and the parison comes into contact with the first and second molds and the parison blocks openings of the cavities, the first, second, and third air passages may be connected to the air pump so that the cavities are vacuumized; in a third stage in which the combining of the first and second molds proceeds and the body portion of the intermediate mold and the parison are inserted into the cavities and the forming of the parison into the semi-finished products proceeds, the air passages of the first, second, and third air passages, which are sealed by the parison, communicate with the atmosphere and serve as the air vent, and the remaining air passages that remain unsealed by the parison are connected to the air pump and sustain the cavities to be vacuumized; and in a fourth stage in which the combining of the first and second molds is terminated and the forming of the parison into the semi-finished products is completed, the first, second, and third air passages may communicate with the atmosphere and serve as the air vent.

In the third stage, the first, second, and third air passages may be sealed by the parison in a sequence of the first, the third, and the second air passages.

According to embodiments of the present invention, when the parison is famed into the semi-finished products having a shape of the fuel tank, the semi-finished products are manufactured by press forming using the first and second molds and the intermediate mold instead of blow molding, whereby the manufactured semi-finished products can have uniform cross-section thickness over the entire area. Accordingly, the manufactured plastic fuel tank can have uniform dimension in the cross-sectional thickness, thereby realizing uniform cross-sectional thickness of the final product. As a result, the final product that is the manufactured plastic fuel tank can have improved durability and improved quality.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A to 1I are views showing processes of forming a plastic fuel tank;

FIGS. 2A to 2I are views showing processes of forming a plastic fuel tank using an apparatus for forming a plastic fuel tank for a vehicle according to embodiments of the present invention; and

FIGS. 3 to 5 are views showing the apparatus according to embodiments of the present invention.

FIGS. 6A to 6D are views showing the apparatus according to embodiments of the present invention.

### DETAILED DESCRIPTION

Hereinbelow, an apparatus for forming a plastic fuel tank for a vehicle according to embodiments of the present invention will be described in detail with reference to the accompanying drawings. Throughout the drawings, the same reference numerals will refer to the same or like parts.

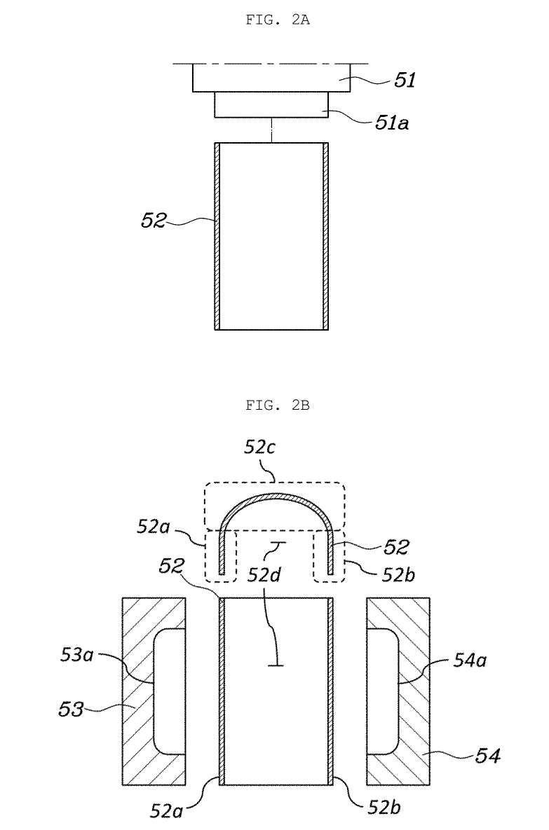

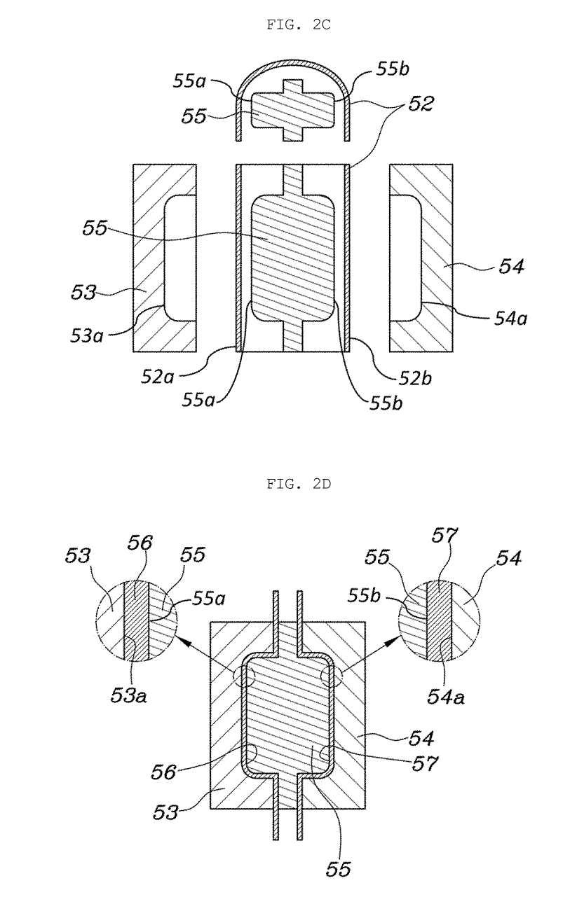

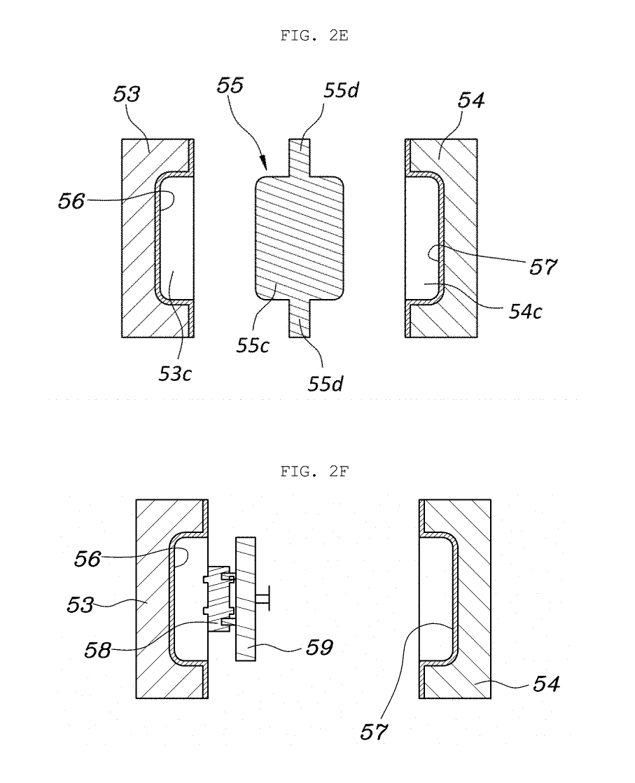

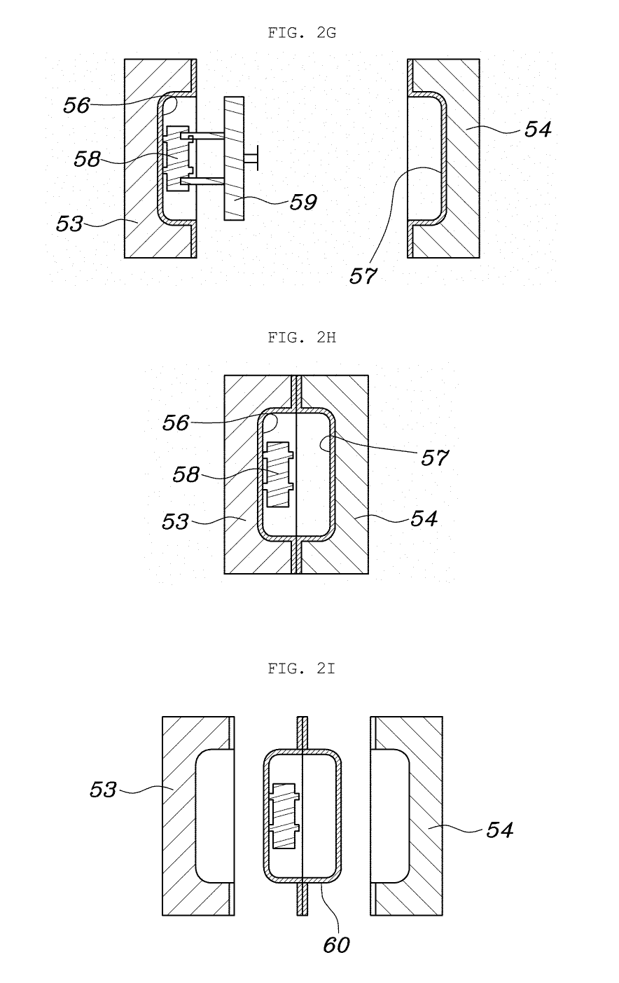

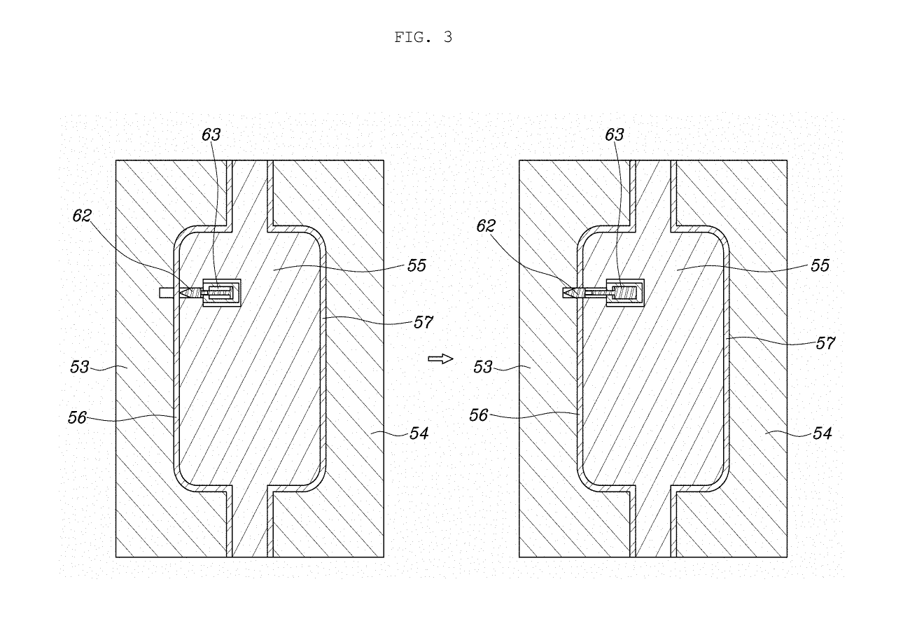

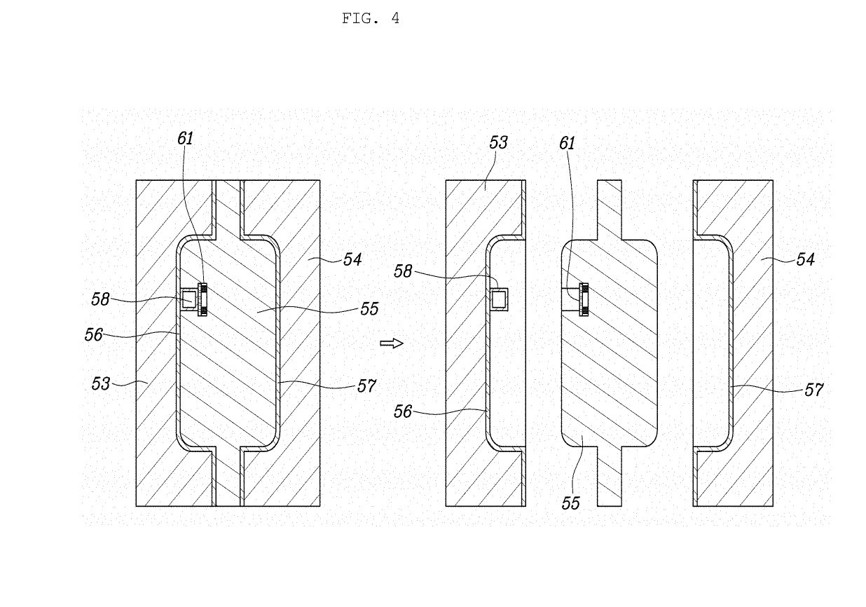

One aspect of the present invention provides a method for manufacturing a fuel tank. The method includes providing a plastic resin parison 52. The parison 52 includes a first wall 52a and a second wall 52b opposing each other with a gap 52d therebetween (FIG. 2B). In embodiments, the parison 52 is a single piece parison comprising a curved third wall 52c connecting two opposing flat walls 52a, 52b.

The method includes providing a first outer mold 53 and a second outer mold 54. The first outer mold 53 has a first inner surface 53a corresponding to an outer surface of the fuel tank. The second outer mold 54 has a second inner surface 54a corresponding to an outer surface of the fuel tank (FIG. 2B). The first outer mold 53 has a first recess 53c corresponding to an outer structure of the fuel tank. The second outer mold 54 has a second recess 53c corresponding to an outer structure of the fuel tank.

The method includes providing an inner mold 55 corresponding to an inner shape of the tank. The inner mold 55 comprises a first outer surface 55a corresponding to an inner surface of the fuel tank (FIG. 2C). The inner mold further comprises a second outer surface 55b facing away from the first outer surface and corresponding to another inner surface of the fuel tank.

The method includes arranging the plastic resin parison 52, the first outer mold, the second outer mold and the an inner mold (as shown in FIG. 2C) such that the first outer mold 53, the first wall of 52a the parison 52, the inner mold 55, the second wall 52b of the parison, and the second outer mold 54 are arranged in order. In embodiments, the gap 52d between the first and second walls 52a, 52b of the parison 52 is big enough to receive the entirety of inner mold 55 therein. A first mold configuration (a portion of the inner mold body 55c comprising the first outer surface 55a) is aligned with the first recess 53c. A second mold configuration (a portion of the inner mold body 55c comprising the second outer surface 55b is aligned with the second recess 54c.

Subsequently to arranging the molds and the parison, at least one the first and second outer molds 353, 54 is moving toward the inner mold 55 to press and deform the parison 52 into an intermediate product (FIG. 2D). The first wall 52a of the parison is pressed or pressurized by the first inner surface 53a of the first outer mold 53 and by the first outer surface 55a of the inner mold 55 to form a first wall 56 of the intermediate product. The second wall 52b of the parison is pressed or pressurized by the second inner surface 54a of the second outer mold 54 and by the second outer surface 55b of the inner mold 55 to form a second wall 57 of the intermediate product. In embodiments, when the parison 52 is deformed into the intermediate product, the first wall 56 contacts the first inner surface 53a and the first outer surface 55a, and the second wall 57 contacts the second inner surface 54a and the second outer surface 55b (circled views in FIG. 2D). In embodiments, the first and second mold configurations of the inner mold body 55c are received in the first and second recesses 53c, 54c respectively.

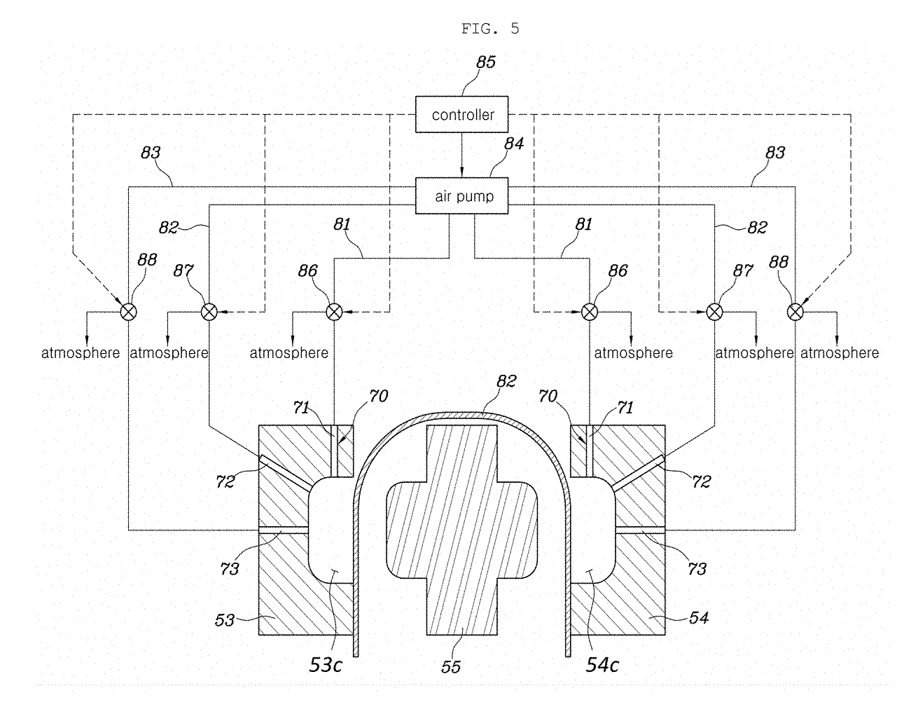

Subsequent to press molding to deform parison 52 into an intermediate product, at least one of the first and second outer molds 53, 54 is moved back (FIG. 2E) such that the intermediate product 56, 57 are detached from the inner mold 55 while the first and second walls 56, 57 of the intermediate product maintains contact with the inner surfaces 53a, 54a of the outer molds 53, 54 respectively. In embodiments, prior to moving back the first and second outer molds, additional processes shown in FIG. 3 and FIG. 4 can be performed. In embodiments, prior to moving back the first and second outer molds, the third wall 52c removed/scrapped for separating the two walls 56, 57 of the intermediate.

Subsequently, (7) an additional plastic part 58 is attached to an inner surface of the first wall 56 of the intermediate product while the first wall 56 of the intermediate product remain attached to the first outer mold 53. Prior to or subsequent to attaching the additional plastic part 58, the inner mold is moved such that the inner mold is no longer between the first and second outer molds.

Subsequently, (8) at least one of the first and second outer is moved such that the first and second walls of the intermediate product are heat-welded to form an inner space of the fuel tank enclosing the additional plastic part (FIG. 2I).

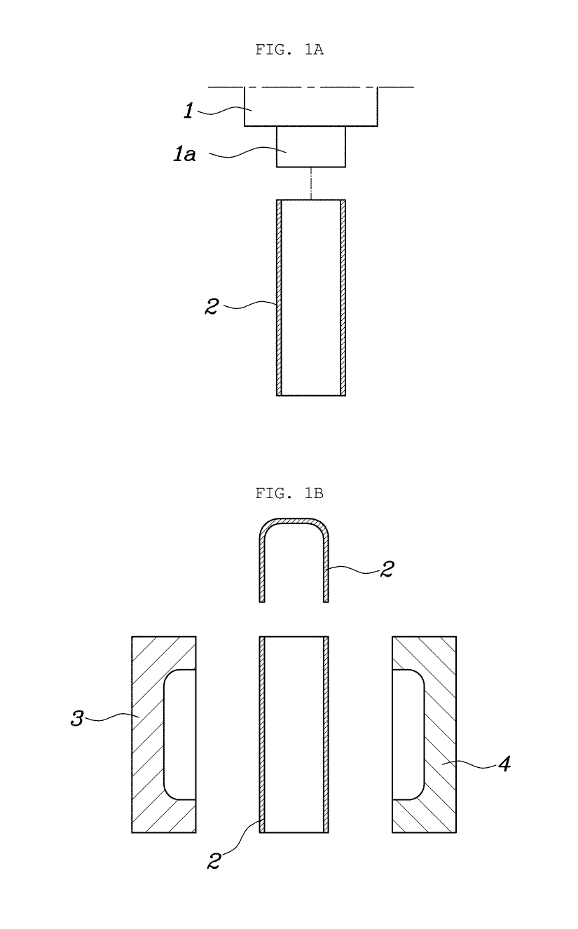

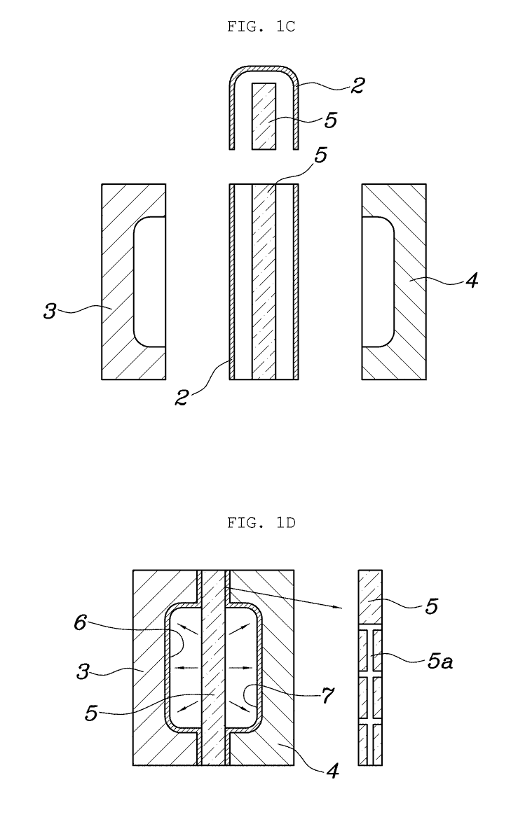

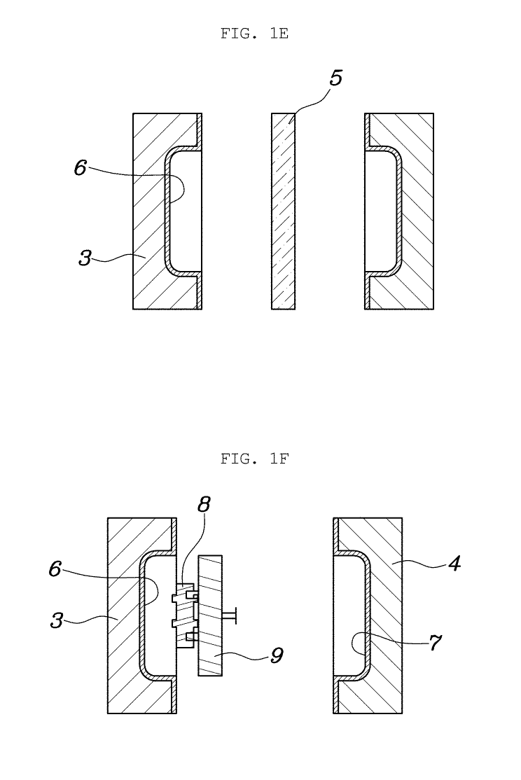

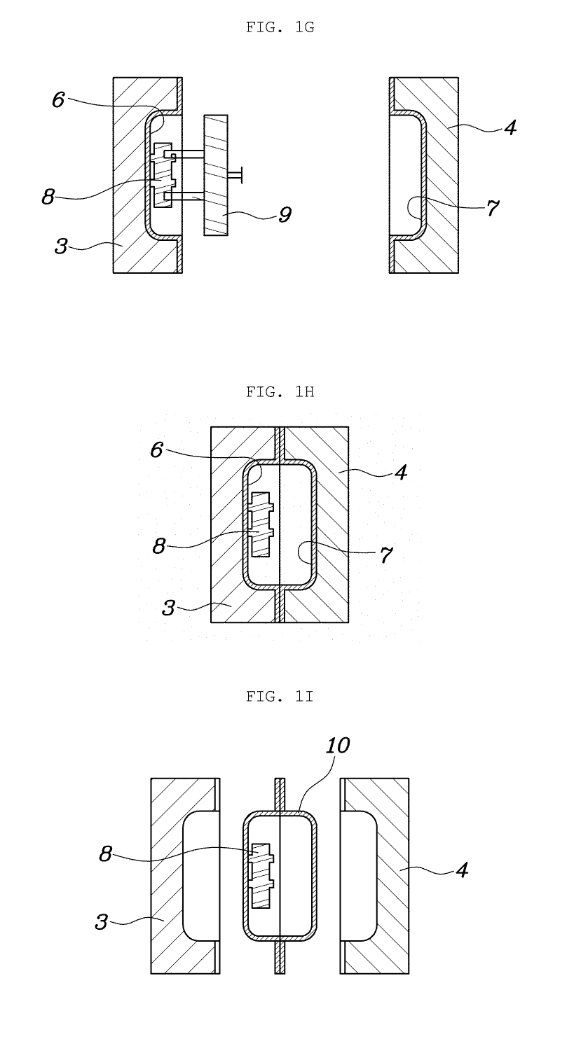

As an example of the forming process, there is a method using an intermediate mold, which will be described with reference to FIGS. 1A to 1I.

When the plastic material is melted as a molten resin in a melting machine by high temperature heat, as shown in FIG. 1A, the molten resin is extruded into a parison 2 having a certain shape through a head core 1a of an extruder. Then, as shown in FIG. 1B, the extruded parison 2 is moved into a space defined between first and second molds 3 and 4.

Although the parison 2 having a C-shaped cross-section is shown as an example, it may be a twin-sheet parison.

After the parison 2 is moved into the space defined between the first and second molds 3 and 4, as shown in FIG. 1C, the intermediate mold 5 is inserted into the parison 2. Then, as shown in FIG. 1D, the first and second molds 3 and 4 are combined and closed, and as the high-pressure air is discharged through the intermediate mold, the parison 2 is brought into contact with the surfaces of cavities of the first and second molds 3 and 4, whereby the parison is blow-molded into semi-finished products 6 and 7 having a shape of the fuel tank.

For blow molding of the parison 2, an air hole 5a is formed in the intermediate mold 5, and the air hole 5a has a structure connected to an externally located pneumatic device.

After the blow molding, as shown in FIG. 1E, the combined first and second molds 3 and 4 are separated and opened, and the intermediate mold 5 is drawn out of the first and second molds 3 and 4. Then, as shown in FIG. 1F, a gripper 9 to which a plastic part is clamped is inserted between the first and second molds 3 and 4, and joins the plastic part 8 onto the inside surface of the semi-finished product 6 by heat welding as shown in FIG. 1G. Then, the gripper 9 is removed after the plastic part 8 and the semi-finished product 6 are joined together, and as shown in FIG. 1H, the separated first and second molds 3 and 4 are combined again whereby the semi-finished products 6 and 7 are heat-welded together and the plastic fuel tank 10 is finally manufactured as shown in FIG. 1I.

However, the plastic fuel tank 10 manufactured as described above is problematic in that dimension in the cross-sectional thickness is not uniform, and this non-uniformity of the cross-sectional thickness causes durability and quality problems.

In other words, the apparatus provides high-pressure air to the parison 2 using the intermediate mold 5, whereby the parison 2 is blow-molded into the semi-finished products 6 and 7 having a shape of the fuel tank. However, it is difficult to control pressure of air discharged to the parison 2 to act evenly over the entire area of the parison 2. As a result, since the cross-section thickness of the semi-finished products 6 and 7 manufactured by blow molding is not uniform over the entire area, the finally manufactured plastic fuel tank 10 has non-uniform dimension in the cross-sectional thickness, and thus durability and quality problems occur due to the non-uniformity of the cross-sectional thickness.

As an example of the forming process, there is a method using an intermediate mold, which will be described with reference to FIGS. 1A to 1I.

When the plastic material is melted as a molten resin in a melting machine by high temperature heat, as shown in FIG. 1A, the molten resin is extruded into a parison 2 having a certain shape through a head core 1a of an extruder. Then, as shown in FIG. 1B, the extruded parison 2 is moved into a space defined between first and second molds 3 and 4.

Although the parison 2 having a C-shaped cross-section is shown as an example, it may be a twin-sheet parison.

After the parison 2 is moved into the space defined between the first and second molds 3 and 4, as shown in FIG. 1C, the intermediate mold 5 is inserted into the parison 2. Then, as shown in FIG. 1D, the first and second molds 3 and 4 are combined and closed, and as the high-pressure air is discharged through the intermediate mold, the parison 2 is brought into contact with the surfaces of cavities of the first and second molds 3 and 4, whereby the parison is blow-molded into semi-finished products 6 and 7 having a shape of the fuel tank.

For blow molding of the parison 2, an air hole 5a is formed in the intermediate mold 5, and the air hole 5a has a structure connected to an externally located pneumatic device.

After the blow molding, as shown in FIG. 1E, the combined first and second molds 3 and 4 are separated and opened, and the intermediate mold 5 is drawn out of the first and second molds 3 and 4. Then, as shown in FIG. 1F, a gripper 9 to which a plastic part is clamped is inserted between the first and second molds 3 and 4, and joins the plastic part 8 onto the inside surface of the semi-finished product 6 by heat welding as shown in FIG. 1G. Then, the gripper 9 is removed after the plastic part 8 and the semi-finished product 6 are joined together, and as shown in FIG. 1H, the separated first and second molds 3 and 4 are combined again whereby the semi-finished products 6 and 7 are heat-welded together and the plastic fuel tank 10 is finally manufactured as shown in FIG. 1I.

However, the plastic fuel tank 10 manufactured as described above is problematic in that dimension in the cross-sectional thickness is not uniform, and this non-uniformity of the cross-sectional thickness causes durability and quality problems.

In other words, the apparatus provides high-pressure air to the parison 2 using the intermediate mold 5, whereby the parison 2 is blow-molded into the semi-finished products 6 and 7 having a shape of the fuel tank. However, it is difficult to control pressure of air discharged to the parison 2 to act evenly over the entire area of the parison 2. As a result, since the cross-section thickness of the semi-finished products 6 and 7 manufactured by blow molding is not uniform over the entire area, the finally manufactured plastic fuel tank 10 has non-uniform dimension in the cross-sectional thickness, and thus durability and quality problems occur due to the non-uniformity of the cross-sectional thickness.

FIGS. 2A to I shows a process of forming a plastic fuel tank using the apparatus according to embodiments of the present invention.

When a plastic material is melted into a molten resin by high temperature heat in a melting machine, as shown in FIG. 2A, the molten resin is extruded into a parison 52 having a certain shape through a head core 51a of an extruder 51, and then as shown in FIG. 2B, the extruded parison 52 is moved into a space defined between first and second molds 53 and 54.

Although the parison 52 having a C-shaped cross-section is shown as an example, it may be a twin-sheet parison.

After the parison 52 is moved into the space defined between the first and second molds 53 and 54, as shown in FIG. 2C, an intermediate mold 55 is inserted into the parison 52. Then, as shown in FIG. 2D, the first and second molds 53 and 54 are combined and closed whereby the parison 52 is brought into contact with surfaces of cavities (recesses) 53c and 54c of the first and second molds 53 and 54, and is formed into semi-finished products 56 and 57 having a shape of the fuel tank.

In other words, when the parison 52 is formed into the semi-finished products 56 and 57, the intermediate mold 55 is positioned inside the parison 52 and serves as a core. When the first and second molds 53 and 54 are combined, the first and second molds 53 and 54 press the outer surface of the parison 52 and the intermediate mold 55 supports the inner surface of the parison 52 whereby the parison 52 is formed into the semi-finished products 56 and 57.

A certain apparatus for forming the parison into the semi-finished product employs blow molding in which high-pressure air discharged through the intermediate mold press the inner surface of the parison whereby the parison is formed into the semi-finished product. The semi-finished product manufactured by blow molding as described above is problematic in that the cross-sectional thickness of the semi-finished product is not uniform over the entire area, so the uniformity of the cross-sectional thickness is decreased. Accordingly, the manufactured plastic fuel tank has non-uniform dimension in the cross-sectional thickness, whereby durability and quality problems occur due to non-uniformity of the cross-sectional thickness.

However, the apparatus according to certain embodiments of the present invention is configured such that the intermediate mold 55 is positioned inside the parison 52 and serves as the core for supporting the parison 52 as in general press working, and when the first and second molds 53 and 54 are combined, the first and second molds 53 and 54 press the outer surface of the parison 52 and the intermediate mold 55 supports the inner surface of the parison 52 whereby the parison 52 is formed into the semi-finished products 56 and 57. The semi-finished products 56 and 57, which are formed in the same manner as the pressing working, have uniform cross-sectional thickness over the entire area and thus uniformity of the cross-sectional thickness is increased. Consequently, the manufactured plastic fuel tank has uniform dimension in the cross-sectional thickness, thereby significantly improving durability and quality.

The intermediate mold 55 includes a body portion 55c inserted into the cavities 53c and 54c of the first and second molds 53 and 54 when the first and second molds 53 and 54 are combined, and a flange portion 55d protruding outward from the body portion 55c, and positioned between the first and second molds 53 and 54 at a position outside the cavities 53c and 54c when the first and second molds 53 and 54 are combined, wherein the body portion 55c of the intermediate mold 55 has a rectangular-shaped cross section having round corners.

In the case of the semi-finished products 56 and 57 manufactured using the apparatus, portions formed by the body portion 55c of the intermediate mold 55 become the plastic fuel tank and remaining portions formed by the flange portion 55d of the intermediate mold 55 becomes scrap, which will be cut and discarded in the following process.

Accordingly, in the case that the body portion 55c of the intermediate mold 55 has the rectangular-shaped cross section having round corners as in embodiments of the present invention, the parison 52 can be more flexibly curved at the time of being formed into the semi-finished products 56 and 57, whereby the extension rate can be lowered. Consequently, it is possible to minimize a change in the cross-sectional thickness of the manufactured semi-finished products 56 and 57.

After forming the semi-finished products 56 and 57 as described above, as shown in FIG. 2E, the combined first and second molds 53 and 54 are separated and opened, the intermediate mold 55 is drawn out of the first and second molds 53 and 54. Then, as shown in FIG. 2F, the gripper 59 to which the plastic part 58 is clamped is inserted between the first and second molds 53 and 54 and joins the plastic part 58 onto the inner surface of the semi-finished product 56 by heat welding as shown in FIG. 2G. The gripper 59 is drawn out of the molds after the plastic part 58 and the semi-finished products are joined together. Then, as shown in FIG. 2H, as the first and second molds 53 and 54 are combined again, the semi-finished products 56 and 57 of the first and second molds 53 and 54 are heat-welded together, whereby the production of the fuel tank 60 is complete as shown in FIG. 2I.

Meanwhile, as described above, the plastic part 58 can be heat-welded onto the inner surface of the semi-finished product 56 by using the gripper 59. However, as shown in FIG. 4, the plastic part 58 may be heat-welded onto the inner surface of the semi-finished product 56 by using an actuator 61 provided integrally with the intermediate mold 55.

In other words, as shown in FIG. 4, when the forming of the parison into the semi-finished products is completed in a state in which the parison 52 is moved into the space defined between the first and second molds 53 and 54, the intermediate mold 55 is inserted into the parison 52, the first and second molds 53 and 54 are combined, the plastic part 58 and the actuator 61 are located in the body portion 55c of the intermediate mold 55 until the forming of the parison 52 into the semi-finished products 56 and 57 is completed, and the first and second molds 53 and 54 are combined, the plastic part 58 protrudes out of the body portion 55c by operation of the actuator 61 and is heat-welded onto the inner surface of the semi-finished product 56.

The actuator 61 may be a pneumatic actuator, but is not limited thereto.

As described above, in the case that the intermediate mold 55 is provided with the actuator 61 for heat welding of the plastic part 58, there is no need for provision of the gripper 59. Accordingly, it is possible to reduce costs and significantly shorten the work cycle, thereby improving productivity.

Further, as shown in FIG. 3, the intermediate mold 55 may further include an actuator 63 having a needle pin 62 forming a hole at the semi-finished product 56.

In other words, as shown in FIG. 3, when the forming of the parison into the semi-finished products 56 and 57 is completed in a state in which the parison 52 is moved into the space defined between the first and second molds 53 and 54, the intermediate mold 55 is inserted into the parison 52, the first and second molds 53 and 54 are combined, the needle pin 62 and the actuator 63 are located inside the body portion 55c of the intermediate mold 55 until the forming of the parison 52 into the semi-finished products 56 and 57 is completed, and the first and second molds 53 and 54 are combined, the needle pin 62 protrudes out of the body portion 55c by operation of the actuator 63 and forms the hole at a predetermined portion of the semi-finished product 56.

A separate plastic part is engaged to a hole formed in the semi-finished product 56.

The actuator 63 may be a pneumatic actuator, but is not limited thereto.

Further, as shown in FIG. 5, embodiments of the present invention further includes: a plurality of air passages 70 provided at the first and second molds 53 and 54, and communicating with the cavities 53c and 54c of first and second molds 53 and 54; an air pump 84 connected to the air passages 70 through air lines 81, 82, and 83; and control valves 86, 87, and 88 provided on the air lines 81, 82, and 83, respectively, and configured to allow the air passages 70 and the air pump 84 to be connected to each other and to allow the air passages 70 and the atmosphere to communicate with each other in accordance with control of a controller 85.

In the horizontal cross-section of the first and second molds 53 and 54, the air passages 70 include first passages 71 passing through horizontal walls of the cavities 53c and 54c, second passages 72 passing through corners of the cavities, and third passages 73 passing through vertical walls of the cavities.

The air passages 70 are provided to improve formability when forming the parison 52 into the semi-finished products 56 and 57. The controller 85 controls operation of the control valves 86, 87, and 88 in accordance with forming steps, whereby air in the cavities 53c and 54c is discharged to the outside or spaces of the cavities 53c and 54c are vacuum sealed.

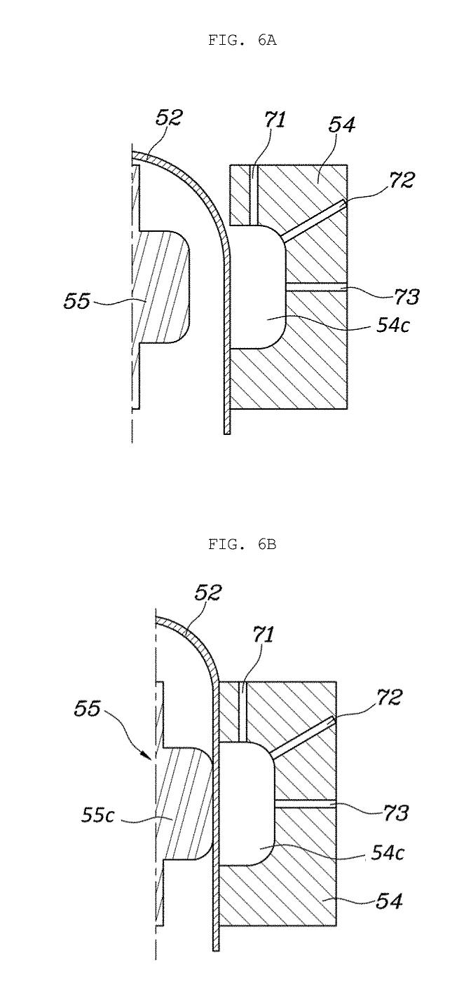

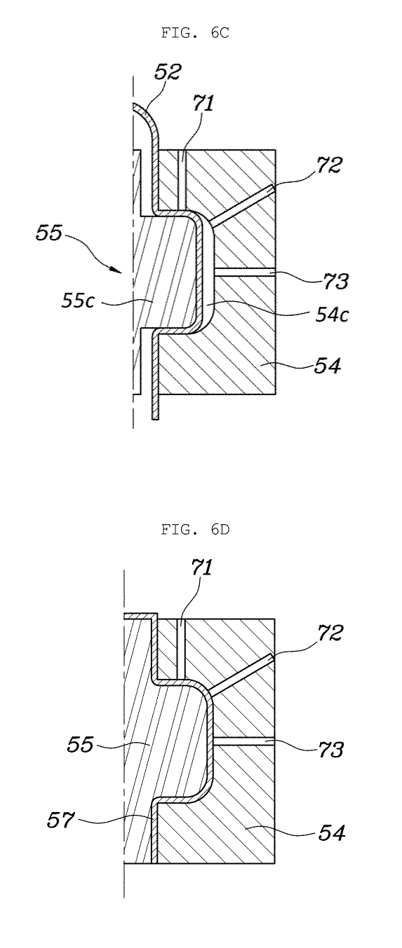

In other words, as shown in FIG. 6A, in the first stage in which the intermediate mold 55 is inserted into the parison 52 before combining of the first and second molds 53 and 54 begins and forming of the parison 52 into the semi-finished products 56 and 57 begins, the first, second, and third air passages 71, 72, and 73 communicate with the atmosphere and serve as an air vent.

Then, as shown in FIG. 6B, in a second stage the combining of the first and second molds 53 and 54 begins and the parison 52 comes into contact with the first and second molds 53 and 54 and the parison 52 blocks the openings of the cavities 53c and 54c, the first, second, and third air passages 71, 72, and 73 are connected to the air pump 84 whereby the cavities 53c and 54c are vacuumized. Accordingly, as the combining of the first and second molds 53 and 54 proceeds, the body portion 55c of the intermediate mold 55 and the parison 52 are more efficiently inserted into the cavities 53c and 54c.

Thereafter, as shown in FIG. 6C, in a third stage in which the combining of the first and second molds 53 and 54 proceeds continuously and the body portion 55c of the intermediate mold 55 and the parison 52 are inserted into the cavities 53c and 54c and the forming of the parison 52 into the semi-finished products 56 and 57 proceeds, the air passages 71 of the first, second, and third air passages 71, 72, and 73, which are sealed by the parison 52 communicate with the atmosphere and serve as an air vent, while the remaining air passages 72 and 73 that remain unsealed by the parison 52 are connected to the air pump 84 and sustain the cavities 53c and 54c to be vacuumized.

In the case that the first passages 71 sealed by the parison 52 communicate with the atmosphere and serve as an air vent, the body portion 55c of the intermediate mold 55 and the parison 52 are more efficiently inserted into the cavities 53c and 54c. In the case that the cavities 53c and 54c are maintained in the vacuum state by the second and third air passages 72 and 73 that remain unsealed by the parison 52, formability can be enhanced when the parison 52 is formed into the semi-finished products 56 and 57.

Finally, as shown in FIG. 6D, in a fourth stage in which the combining of the first and second molds 53 and 54 is terminated and the forming of the parison 52 into the semi-finished products 56 and 57 is completed, the first, second, and third air passages 71, 72, and 73 are sealed by the parison 52 and communicate with the atmosphere to serve as an air vent.

Meanwhile, in the third stage, the first, second, third air passages 71, 72, and 73 are sealed by the parison 52 in a sequence of the first, the third, and the second air passages, which results from the characteristics of the corners of cavities 53c and 54c. Accordingly, air is allowed to remain ultimately in the corners of the cavities 53c and 54c, thereby enhancing formability when the parison is formed into the semi-finished products 56 and 57.

In certain embodiments of the present invention as described above, when the parison 52 is formed into the semi-finished products 56 and 57 having a shape of the fuel tank, the semi-finished products and 57 are manufactured by press forming using the first and second molds 53 and 54 and the intermediate mold 55 instead of blow molding. Consequently, the manufactured semi-finished products 56 and 57 can have uniform cross-sectional thickness over the entire area, and thus the manufactured plastic fuel tank 60 can have uniform dimension in the cross-sectional thickness, thereby realizing uniform cross-sectional thickness of the final product. As a result, it is possible to improve durability and quality of the final product that is the manufactured plastic fuel tank 60.

Although embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for forming a plastic fuel tank for a vehicle, the apparatus foiling a parison into semi-finished products having a shape of the fuel tank and forming the semi-finished products into a finished plastic fuel tank, the apparatus comprising:
first and second molds configured to be combined and separated from each other; and
an intermediate mold configured to be inserted between and withdrawn from the first and second molds,
wherein when the parison is foamed into the semi-finished products, the intermediate mold is positioned inside the parison and serves as a core, and when the first and second molds are combined, the first and second molds press an outer surface of the parison and the intermediate mold supports an inner surface of the parison, whereby the parison is formed into the semi-finished products.

2. The apparatus of claim 1, wherein the intermediate mold includes:
a body portion inserted into cavities of the first and second molds when the first and second molds are combined; and
a flange portion protruding outward from the body portion and positioned between the first and second molds at a position outside the cavities when the first and second molds are combined.

3. The apparatus of claim 2, wherein the body portion of the intermediate mold has a rectangular-shaped cross section having round corners.

4. The apparatus of claim 2, wherein the body portion of the intermediate mold is provided with a needle pin forming a hole at at least one of the semi-finished products and a plastic part heat-welded onto an inner surface of the semi-finished product; and
the needle pin and the plastic part are placed inside the body portion of the intermediate mold until the parison is formed into the semi-finished products in a state in which the first and second molds are combined, and after the parison is formed into the semi-finished products in the state in which the first and second molds are combined, the needle pin and the plastic part protrude out of the body portion of the intermediate mold whereby the needle pin forms the hole at the semi-finished product and the plastic part is heat-welded onto the inner surface of the semi-finished product.

5. The apparatus of claim 2, further comprising:
a plurality of air passages provided at the first and second molds, and communicating with the cavities of first and second molds;
an air pump connected to the air passages through a plurality of air lines; and
control valves provided on the air lines, respectively, and configured to allow the air passages and the air pump to be connected to each other and to allow the air passages and the atmosphere to communicate with each other in accordance with control of a controller.

6. The apparatus of claim 5, wherein in a horizontal cross-section of the first and second molds, the air passages include first passages passing through horizontal walls of the cavities, second passages passing through corners of the cavities, and third passages passing through vertical walls of the cavities.

7. The apparatus of claim 6, wherein in a first stage in which the intermediate mold is inserted into the parison before combining of the first and second molds begins and forming of the parison into the semi-finished products begins, the first, second, and third air passages communicate with the atmosphere and serve as an air vent;
in a second stage in which the combining of the first and second molds begins and the parison comes into contact with the first and second molds and the parison blocks openings of the cavities, the first, second, and third air passages are connected to the air pump so that the cavities are vacuumized;
in a third stage in which the combining of the first and second molds proceeds and the body portion of the intermediate mold and the parison are inserted into the cavities and the forming of the parison into the semi-finished products proceeds, the air passages of the first, second, and third air passages, which are sealed by the parison, communicate with the atmosphere and serve as the air vent, and the remaining air passages that remain unsealed by the parison are connected to the air pump and sustain the cavities to be vacuumized; and
in a fourth stage in which the combining of the first and second molds is terminated and the forming of the parison into the semi-finished products is completed, the first, second, and third air passages communicate with the atmosphere and serve as the air vent.

8. The apparatus of claim 7, wherein in the third stage, the first, second, and third air passages are sealed by the parison in a sequence of the first, the third, and the second air passages.

9. A method of manufacturing a fuel tank, the method comprising:
providing a plastic resin parison comprising a first wall and a second wall opposing each other with a gap therebetween;
providing a first outer mold and a second outer mold, the first outer mold comprising a first recess, the second outer mold comprising a second recess;
providing an inner mold comprising a first mold configuration corresponding to the first recess, the inner mold further comprising a second mold configuration corresponding to the second recess;
arranging the plastic resin parison, the first outer mold, the second outer mold and the an inner mold such that the first outer mold, the first wall of the parison, the inner mold, the second wall of the parison, and the second outer mold are arranged in order, such that the first mold configuration and the first recess are aligned, and further such that the second mold configuration and the second recess are aligned;
moving the first and second outer molds toward the inner mold to deform the parison into an intermediate product such that the first mold configuration is received in the first recess and the second mold configuration is received in the second recess, wherein the first wall of the parison is compressed between by the first recess and the first mold configuration to form a first wall of the intermediate product, wherein the second wall of the parison is compressed between the second recess and the second mold configuration to form a second wall of the intermediate product;
moving the first and second outer molds away from the inner mold such that the intermediate product are separated from the inner mold while a first portion of the first wall of the intermediate product stays inside the first recess and a second portion of the second wall of the intermediate product stays inside the second recess;
attaching a device to be placed inside the fuel tank to an inner surface of the first wall of the intermediate product while the first portion of the first wall of the intermediate product remains inside the first recess;
moving the inner mold such that the inner mold is not interposed between the first and second outer molds;
moving the first outer mold relative to the second outer mold such that the first and second walls of the intermediate product are combined to form an inner space of the fuel tank enclosing the device; and
heat-welding the first and second walls of the intermediate product to provide the fuel tank.

10. The method of claim 9, wherein the parison further comprises a third wall connecting the first wall and the second wall of the parison.

11. The method of claim 10 further comprising,
subsequent to moving the first and second outer molds to form the intermediate product, removing the third wall to separate the first wall of the intermediate product from the second wall of the intermediate product.

12. The method of claim 9, wherein the first wall and the second wall of the parison are substantially flat.
